(19) United States
(12) Patent Application Publication
(10) Pub. No.: US 2005/0117479 A1
(43) Pub. Date: Jun. 2, 2005

(54) Method for performing optimal recording power calibration in recorder and recording medium therefor

(75) Inventor: Yeo Han Yun, Pyungtaek-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/980,181

(22) Filed: Nov. 4, 2004

(30) Foreign Application Priority Data
Nov. 4, 2003 (KR) 10-2003-0077768

(51) Int. Cl. G11B 5/09

(52) U.S. Cl. 369/47.53

(57) ABSTRACT

A recording medium and a method and apparatus for controlling an optimal recording power calibration (OPC) are provided. The method includes reading a last time information recorded on the recording medium, comparing the read time information with a current time information, and selectively performing an OPC operation based on the comparison result.

This application claims the priority benefit of Patent Application No. 2003-077768 filed on Nov. 4, 2003 in Republic of Korea, the entire contents of which are herein fully incorporated by reference.

### BACKGROUND OF THE INVENTION

1. Field of the Invention

The present invention relates to a method and apparatus for performing an optimal recording power calibration (OPC), which can enable an OPC operation to be selectively performed in a recorder for recording data on a recording medium such as a digital versatile disc-rewritable (DVD-RW).

2. Description of the Related Art

Recently, high-density recording mediums capable of permanently recording high-quality video and audio data, for example, digital versatile discs-rewritable (DVDs-RW), have been developed, commercialized and supplied. Furthermore, recorders such as DVD recorders for recording and reproducing data on and from the DVDs-RWs have been developed, commercialized and supplied.

As shown in FIG. 1, a power calibration area (PCA) necessary for performing an OPC operation and a recording management area (RMA) are assigned to a DVD-RW. The PCA and the RMA are positioned at an inner area of the disc before a lead-in zone of the disc.

When a recorder such as a DVD recorder receives a recording command based upon a user request, an OPC operation for recording data on an optical disc are automatically performed. The OPC operation includes a recording operation of predetermined test data and an adjustment operation of a recording power value, so that a beta ratio value indicating an asymmetry ratio of a radio frequency (RF) signal read and detected according to the recorded test data becomes close to zero. In this case, one error correction code (ECC) block having a size of 16 sectors within the PCA is used from an outer circumference direction to an inner circumference direction of the optical disc.

The RMA can contain, among other things, 28 recording management data (RMD) blocks 40 in which recording related data associated with an OPC operation are stored. Each RMD 40 (RMD 1, RMD 2, etc.) in the RMA includes 15 fields (Field 0˜Field 14). The second field (Field 1) of the RMD 1 contains OPC related information as shown in FIG. 2.

FIG. 3 shows a structure of the second field (Field 1) of RMD 1 in FIG. 2. As shown in FIG. 3, a time stamp in which 73^{rd} to 80^{th} bytes 48 (Byte Position 72 to 79) having a size of 8 bytes in the second field (Field 1) are recorded, contains time information relating to the OPC operation. For example, as shown in FIG. 4, hour, minute and second information relating to the OPC operation is recorded in the 1^{st} to 4^{th} bytes of the time stamp, and year, month and day information relating to the OPC operation is recorded in the remaining 5^{th} to 8^{th} bytes of the time stamp. In FIG. 3, “No 1”, “No 2”, “No 3”, etc. represent different drives such that the drive manufacturer IDs in these sections are different from each other.

In the related art, however, each time a user data recording command is received from a user, a recorder such as the existing DVD recorder performs an OPC operation for recording data on the optical disc. This causes a delay in the actual user data recording, because a significant time is spent performing the OPC operation each time a recording command is received.

### SUMMARY OF THE INVENTION

The present invention overcomes the above and other problems and limitations associated with the related art.

It is an object of the present invention to provide a method and apparatus for performing an optimal recording power calibration (OPC) and a recording medium therefor, which can enable an OPC operation to be selectively performed by recording a last OPC time information and a last recording time information in a specific area of the recording medium such as a DVD-RW and by retrieving and referring to the last OPC time information or the last recording time information in the specific area of the recording medium.

In accordance with an aspect of the present invention, there is provided a method for controlling an optimal recording power calibration (OPC) for a recording medium, comprising reading a last time information recorded on the recording medium; first comparing the read time information with a current time information; and selectively performing an OPC operation based on the first comparison result.

In accordance with an aspect of the present invention, there is an apparatus for controlling an optimal recording power calibration (OPC) for a recording medium, comprising a reproducing unit to read a last time information recorded on the recording medium; and a controller to compare the read time information with a current time information and to selectively perform an OPC operation based on the comparison result.

In accordance with an aspect of the present invention, there is provided a recording medium comprising a first area for recording a last optimal recording power calibration (OPC) time information; and a second area adjacent to the first area, for recording a last recording time information.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating a power calibration area (PCA) and a recording management area (RMA) assigned to a DVD-RW according to a related art;

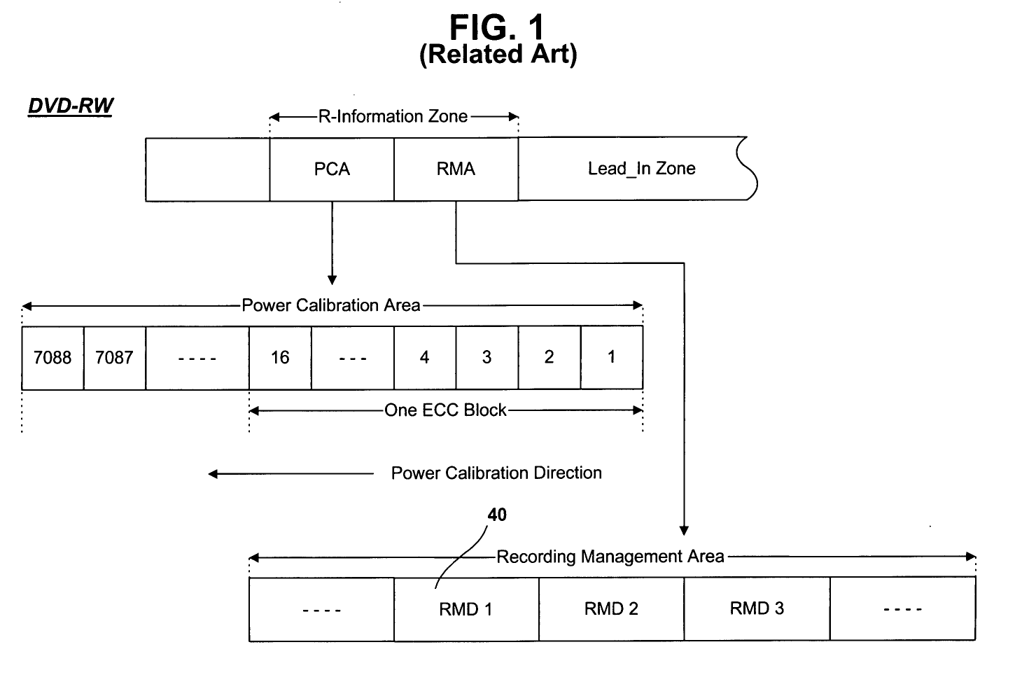

FIG. 2 is a table illustrating a structure of the RMD 1 in FIG. 1;

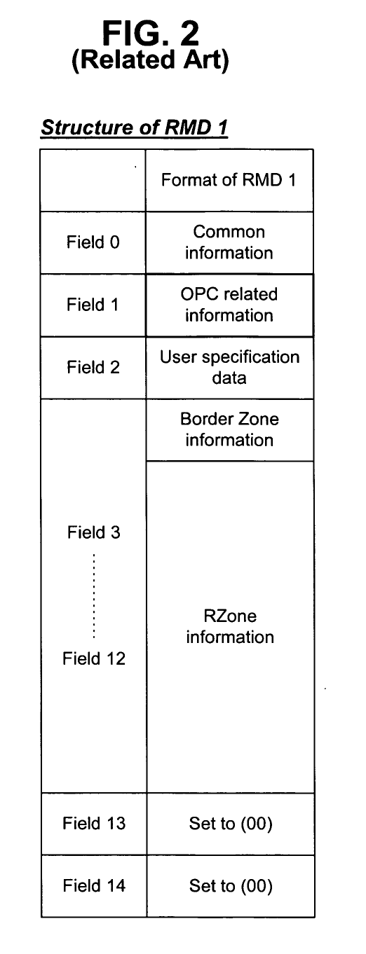

FIG. 3 is a table illustrating optimal power calibration (OPC) related information recorded in the second field (Field 1) of the RMD 1 in FIG. 2;

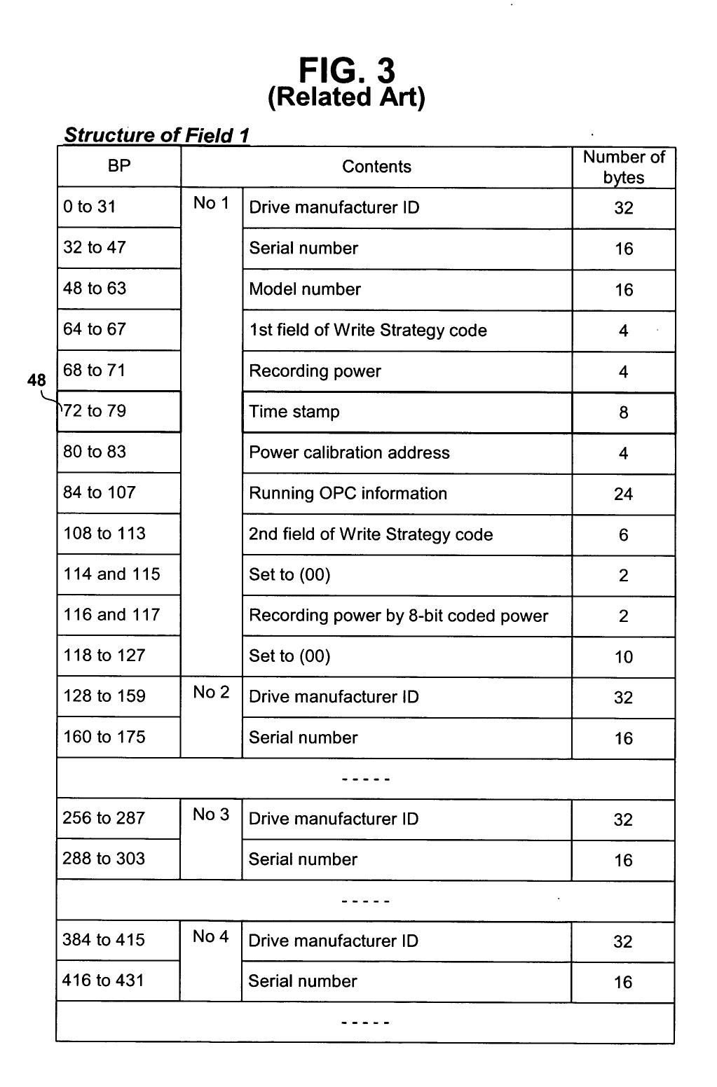

FIG. 4 is a table illustrating information recorded in a time stamp in the OPC related information stored in the Field 1 of the RMD 1 in FIG. 3;

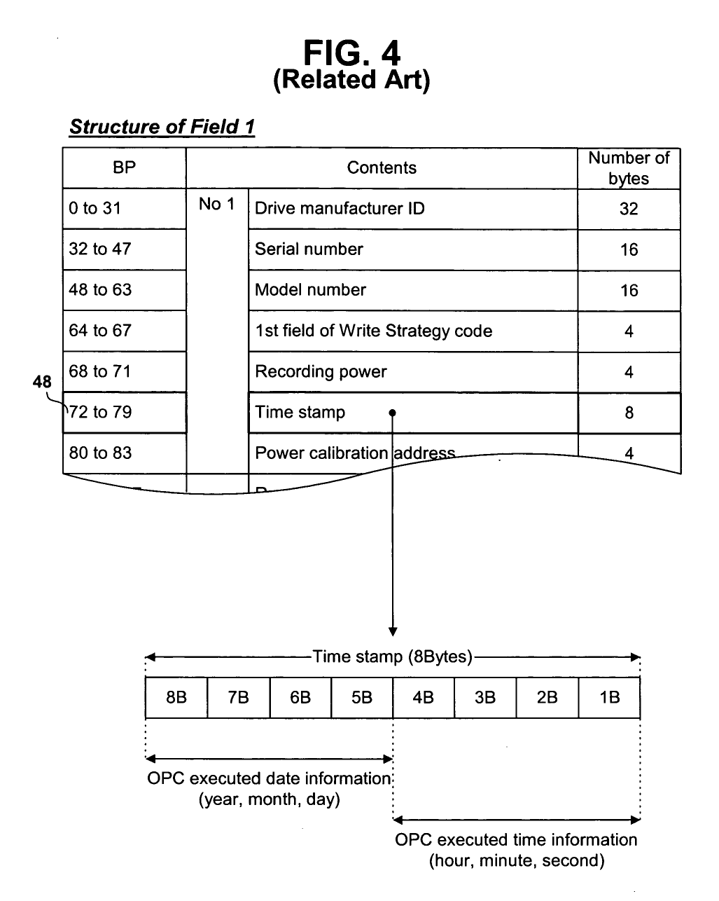

FIG. 5 is a block diagram illustrating a recorder to which an OPC method of the present invention is applicable in accordance with the present invention;

FIG. 6 is a table illustrating information recorded in a time stamp in OPC related information stored in the second field (Field 1) of an RMD such as RMD 1 in accordance with an embodiment of the present invention; and

FIG. 7 is a flow chart illustrating the steps of an OPC method in accordance with the present invention.

### DETAILED DESCRIPTION OF PREFERRED EMBODIMENTS

Hereinafter, preferred embodiments of a method for performing optimal recording power calibration (OPC) in a recorder and a recording medium therefor in accordance with the present invention will be described in detail with reference to the annexed drawings.

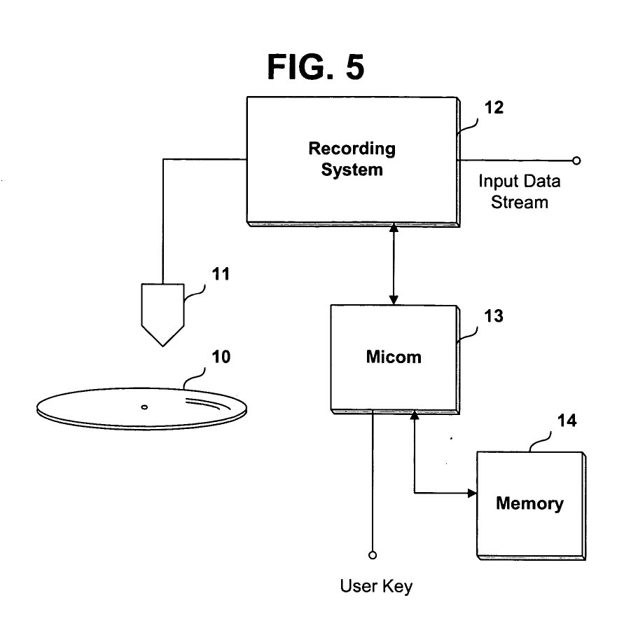

First, the OPC method in accordance with the present invention can be applied to a recorder such as a DVD recorder, or to any other suitable device/system. For example, the recorder in which the steps of the OPC methods of the present invention can be applied, includes an optical pickup 11, a recording system 12, a microcomputer 13, a memory 14, etc. as shown in FIG. 5. All the components of the recorder are operatively coupled.

The recording system 12 performs an OPC operation for appropriately recording an input data stream on a recording medium 10 such as a rewritable optical disc (e.g., a DVD-RW) according to the operation control of the microcomputer 13.

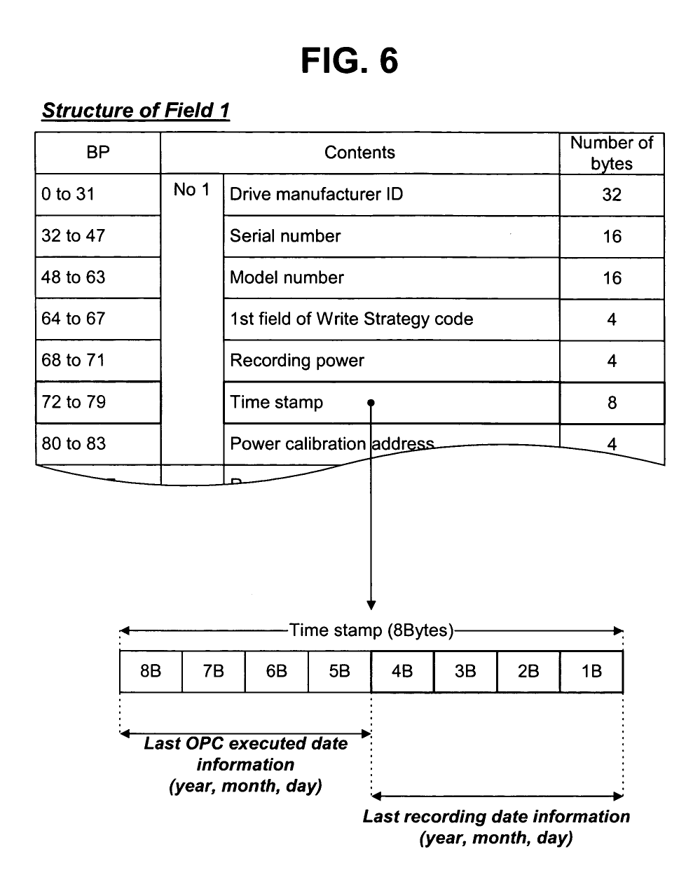

Referring to FIG. 6, according to an embodiment of the present invention, last OPC-executed time/date information (Last_OPC_date) and last recording time/date information (Last_recording_date) are recorded in a specific area of the DVD-RW. The last OPC time information can be recorded and managed on the basis of year, month and day information associated with the last OPC operation. Furthermore, the last recording time information can be recorded on the basis of year, month and day information associated with the last recording operation for recording, e.g., user data, on the disc.

As shown in FIG. 6, the last OPC time information and the last recording time information can be recorded in a time stamp of 73^{rd} to 80^{th} bytes (Bytes 72 to 79) having a record size of 8 bytes in the second field (Field 1) for a RMD such as the RMD 1. The last OPC time information and the last recording time information are adjacent to each other. For example, the last recording time information is recorded in the 1^{st} to 4^{th} bytes of the 8-byte time stamp and identifies the year, month and day of the last data recording time. The last OPC time information is recorded in the remaining 5^{th} to 8^{th} bytes of the 8-byte time stamp and identifies the year, month and day when the last OPC was executed.

Upon receiving a recording command through an interface with the microcomputer 13, the recording system 12 reads and refers to the last recording time information and the last OPC time information of the time stamp recorded within an RMD block of the optical disc, and compares the last recording time information and the last OPC time information with the current time information (Current_date). Based on the comparison results, the OPC operation is selectively performed or skipped. This will be described below in detail.

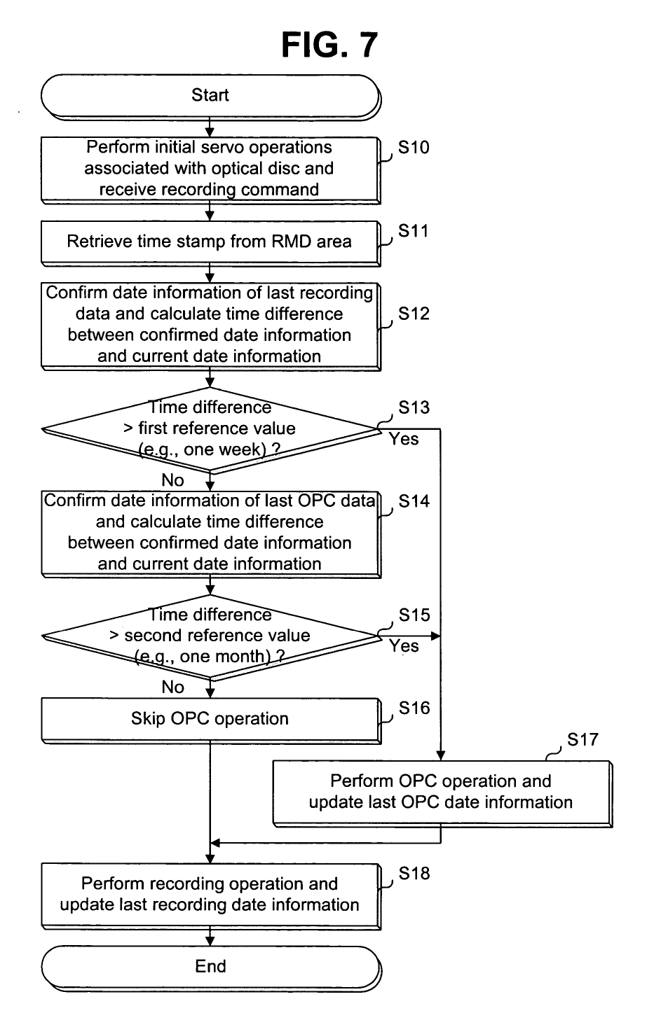

FIG. 7 is a flow chart illustrating the processing steps of the OPC method in accordance with an embodiment of the present invention. This OPC method can be implemented in the recorder of FIG. 5 or in other suitable device/system.

Referring to FIGS. 5-7, where an optical disc such as the DVD-RW 10 is inserted into the recorder, the microcomputer 13 performs a set of initial servo operations such as known focus and tracking servo operations. When a recording command is received according to a user request (S10), the microcomputer 13 controls an operation of the recording system 12.

As described above with reference to FIG. 6, the recording system 12 retrieves the time stamp having a record size of 8 bytes from the second field (Field 1) of a RMD such as RMD 1 (S11).

After the last recording time information (Last_recording_date) recorded in the 1^{st} to 4^{th} bytes is confirmed from the 8-byte time stamp, the last recording time information (Last_recording_date) is compared with the current time information (Current_date), and the time difference between the last recording time information (Last_recording_date) and the current time information (Current_date) is calculated (S12). For example, where the confirmed last recording time is “Oct. 18, 2003” and the current time is “Oct. 20, 2003”, the recording system 12 determines that a time difference (i.e., two days) between the last recording time and the current time is not greater than a preset first reference value, for example, one week.

If the time difference between the last recording time and the current time is not greater than the first reference value (e.g., one week) (S13), the recording system 12 reads and confirms the last OPC time information (Last_OPC_date) recorded in the 5^{th} to 8^{th} bytes of the 8-byte time stamp, compares the confirmed last OPC time information (Last_OPC_date) with the current time information (Current_date), and calculates a time difference between the last OPC time information (Last_OPC_date) and the current time information (Current_date) (S14). For example, where the confirmed last OPC time is “Sep. 25, 2003” and the current time is “Oct. 20, 2003”, the recording system 12 determines that a time difference between the last OPC time and the current time is not greater than a preset second reference value, for example, one month.

If the time difference between the last OPC time and the current time is not greater than the second reference value (S15), the recording system 12 does not perform a new OPC operation (S16), and uses a recording power value recorded during the last OPC operation. As shown in FIG. 6, the optimal recording power value is recorded, e.g., in the 69^{th} to 72^{nd} bytes (Bytes 68 to 71) of the Field 1 of the RMD 1.

For example, if the confirmed last recording time is “Oct. 10, 2003” and the current time is “Oct. 20, 2003”, the recording system 12 determines at step S13 that the time difference between the last recording time and the current time is greater than the preset first reference value, for example, one week, and performs a new OPC operation. (S17)

Furthermore, where the confirmed last OPC time is “Aug. 25, 2003” and the current time is “Oct. 20, 2003”, the recording system 12 determines at step S15 that the time difference between the last OPC time and the current time is greater than the preset second reference value, for example, one month, and performs a new OPC operation (S17).

After the new OPC operation is performed, the last OPC time information is updated to indicate the time (e.g., year, month and day) of completing the new OPC operation and the updated information is recorded in the Field 1 of the RMD 1 (S17). The updating of the last OPC time information for the current drive involves over-writing the previously recorded OPC time information associated with the current drive, such that only one OPC time information associated with the current drive is stored in the Field 1 at any given time.

If the OPC operation has been completely performed or has been skipped, a recording operation is performed (S18). After the recording operation is performed, a set of operations for updating and recording the last recording time information is performed, whereby the updated last recording time information (e.g., year, month and day) is recorded in the Field 1 of the RMD 1. The updating of the last recording time information for the current drive involves over-writing the previously recorded recording time information associated with the current drive, such that only one recording time information associated with the current drive is stored in the Field 1 at any given time.

The first and second reference values used at steps S13 and S16, respectively, can be set to arbitrary values through a result of various tests performed in a process of developing or manufacturing the recorder. In examples, the second reference value is generally greater than the first reference value. The last OPC time information and the last recording time information can be accurately recorded and managed in a time unit, e.g. hour, minute or second, at a resolution higher than the date-level resolution, i.e., year, month, day.

According to the present invention, certain steps in FIG. 7 may be omitted. For instance, in one embodiment, steps S14 and S15 may be omitted such that the OPC may be skipped based only on the last recording time information. In another embodiment, steps S12 and S13 may be skipped such that the OPC may be skipped based only on the last OPC-executed time information.

According to an embodiment of the present invention, before a determination is made as to whether an OPC operation must be performed, drive manufacturer identification (ID) information recorded in the 1^{st} to 32^{nd} bytes (Bytes 0 to 31) of the RMD 1 is retrieved. If the retrieved drive manufacturer ID is not equal to a drive manufacturer ID preset in a recorder, an OPC operation is instantly performed. On the other hand, if the retrieved drive manufacturer ID is equal to the drive manufacturer ID preset in the recorder, the set of operations (S11 to S15 of FIG. 7) is performed so that an OPC operation can be selectively performed. This feature is useful when the recorder system has multiple drives. By checking the drive ID information, the invention ensures that the correct user's drive and settings are used to check and perform the OPC.

As apparent from the above description, the present invention provides a method for performing optimal recording power calibration (OPC) in a recorder and a recording medium therefor, which can avoid performing an unnecessary OPC operation just because a recording command is received and can prevent a delay in starting the actual data recording operation.

Although the preferred embodiments of the present invention have been disclosed for illustrative purposes, those skilled in the art will appreciate that various modifications, additions and substitutions are possible, without departing from the scope of the invention.

1. A method for controlling an optimal recording power calibration (OPC) for a recording medium, comprising:
reading a last time information recorded on the recording medium;
first comparing the read time information with a current time information; and
selectively performing an OPC operation based on the first comparison result.

2. The method of claim 1, wherein in the reading step, the last time information is a last OPC time information pertaining to a last executed OPC operation of the recording medium.

3. The method of claim 2, wherein the selectively performing step performs the OPC operation if the first comparison result indicates that a time difference between the read OPC time information and the current time information is greater than a reference value.

4. The method of claim 2, wherein in the reading step, the OPC time information includes one of the following:
year, month and day information associated with the last executed OPC operation; and
year, month, day, hour, minute and second information associated with the last executed OPC operation.

5. The method of claim 1, wherein in the reading step, the last time information is a last recording information pertaining to a last recording operation of user data on the recording medium.

6. The method of claim 5, wherein the selectively performing step performs the OPC operation if the first comparison result indicates that a time difference between the read last recording time information and the current time information is greater than a reference value.

7. The method of claim 5, wherein in the reading step, the recording time information includes one of the following:
year, month and day information associated with the last recording operation of the user data; and
year, month, day, hour, minute and second information associated with the last recording operation of the user data.

8. The method of claim 6, further comprising:
second comparing a last OPC time information pertaining to a last executed OPC operation of the recording medium, with the current time information, if the first comparison result indicates that the time difference between the read last OPC time information and the current time information is not greater than the reference value; and
selectively performing the OPC operation based on a result of the second comparing step.

9. The method of claim 8, wherein the step of performing the OPC operation based on the result of the second comparing step, performs the OPC operation if the comparison result indicates that a time difference between the read OPC time information and the current time information is greater than a reference value.

10. The method of claim 8, wherein the OPC time information includes year, month and day information associated with the last executed OPC operation, and the recording time information includes year, month, and day information associated with the last recording operation of the user data.

11. The method of claim 1, further comprising:
accessing, by a recording/reproducing device, drive identification (ID) information from the recording medium;
comparing the accessed drive ID information with drive ID information prestored in the recording/reproducing device; and
selectively performing the reading step based on a result of comparing the accessed drive ID information with the prestored drive ID information.

12. An apparatus for controlling an optimal recording power calibration (OPC) for a recording medium, comprising:
a reproducing unit to read a last time information recorded on the recording medium; and
a controller to compare the read time information with a current time information and to selectively perform an OPC operation based on the comparison result.

13. A recording medium comprising:
a first area for recording a last optimal recording power calibration (OPC) time information; and
a second area adjacent to the first area, for recording a last recording time information.

14. The recording medium of claim 13, wherein the last OPC time information pertains to a last executed OPC operation of the recording medium, and the last recording time information pertains to a last recording operation of user data on the recording medium.

15. The recording medium of claim 14, wherein the OPC time information includes year, month and day information associated with the last executed OPC operation, and the recording time information includes year, month, and day information associated with the last executed OPC operation.

16. The recording medium of claim 14, wherein the first area is updated each time an OPC operation is performed, and the second area is updated each time a recording operation of user data is performed.
